(19) United States
(12) Patent Application Publication
(10) Pub. No.: US 2015/0348374 A1
(43) Pub. Date: Dec. 3, 2015

(54) METHODS AND APPARATUS FOR MANIPULATING A DISPLAY OF REELS IN A REEL-SPINNING WAGERING GAME

(71) Applicant: GTECH Canada ULC, Moncton (CA)

(72) Inventor: Reuben Dupuis, Moncton (CA)

(73) Assignee: GTECH Canada ULC, Moncton (CA)

(21) Appl. No.: 14/287,629

(22) Filed: May 27, 2014

(51) Int. Cl. G07F 17/34; G07F 17/32

(52) U.S. Cl. CPC G07F 17/34; G07F 17/3213

(57) ABSTRACT

Techniques for manipulating a display of reels in a reel-spinning wagering game include accessing data representing a plurality of reels of symbols in a starting set of reels, and one or more replacement reels of symbols. A depiction of at least a portion of each of the reels in the starting set may be displayed on a display screen. User input indicating a wager may be received via a machine-user interface, and a first reel spin may be executed. The depiction on the display screen of at least one reel in the starting set may be replaced with a depiction of at least a portion of at least one of the replacement reels to form a modified set of reels depicted on the display screen. A second reel spin may be executed, and a payout may be determined based on the stopping positions of the reels in the modified set.

### BACKGROUND

Modern casinos are increasingly moving toward electronic and computerized implementations for their gaming machines. For example, slot machines historically were mechanical devices whose physical reels could be spun by pulling a lever on the side of the machine. Each symbol on each reel occupied a physical stop having the same probability of occurrence as all other stops on the reel, and the machine would pay out based on the combination of symbols appearing in a line across the reels (the “payline”) when all of the reels stopped spinning. Today, however, mechanical reels in slot machines are typically controlled electronically, such that different payline probabilities can be assigned to different symbols on the reels. The reels can be spun by pushing a button that activates the electronic control, although some machines may retain the traditional lever for entertainment value. In newer video slot machines, the physical reels are replaced by virtual reels whose symbols are displayed on a video screen, controlled by one or more computer processors. Some video slot machines have physical buttons for the player to press, while others are operated via touchscreen.

An electronic gaming machine is typically programmed, via software or firmware, to pay out as winnings, in the long run, a particular percentage of the money that is paid in by players as wagers. This is typically done by setting the probabilities for individual payouts in the machine's control system. For example, if a machine gives a payout of 10 times the player's wager with a probability of 5%, and a payout of 20 times the player's wager with a probability of 2%, then the machine has a theoretical payout percentage of 90%. The remaining 10% of the wagers are kept by the “house” (i.e., the slot machine operator—typically the casino) as profits. The payouts that result from various combinations of symbols appearing on a payline when the reels stop spinning are typically listed in a pay table that may be displayed somewhere on the machine. The probability of each payout can thus be controlled by setting the probabilities of the individual symbols that must co-occur on the payline to produce that payout.

### SUMMARY

One embodiment is directed to a method of manipulating a display of reels in a reel-spinning wagering game, the method comprising: accessing, in one or more data structures stored in one or more processor-readable storage media, data representing a plurality of reels of symbols in a starting set of reels, and one or more replacement reels of symbols; displaying on a display screen a depiction of at least a portion of each of the plurality of reels in the starting set; receiving, via a machine-user interface, user input indicating a wager; and executing stored instructions via at least one processor to execute a first reel spin by modifying the depiction on the display screen to portray the plurality of reels in the starting set spinning, computing a first stopping position for each of the plurality of reels in the starting set, and then modifying the depiction on the display screen to portray each of the plurality of reels in the starting set stopped at its respective first stopping position; replace the depiction on the display screen of at least one of the plurality of reels in the starting set with a depiction of at least a portion of at least one of the one or more replacement reels to form a modified set of reels depicted on the display screen, the modified set of reels comprising at least one reel from the starting set and at least one replacement reel; execute a second reel spin by modifying the depiction of the modified set of reels on the display screen to portray the reels in the modified set spinning, computing a second stopping position for each of the reels in the modified set, and then modifying the depiction on the display screen to portray each of the reels in the modified set stopped at its respective second stopping position; and determine a payout based on the second stopping positions of the reels in the modified set.

Another embodiment is directed to apparatus comprising at least one processor, and at least one processor-readable storage medium storing processor-executable instructions that, when executed by the at least one processor, cause the at least one processor to perform acts comprising: accessing, in one or more data structures, data representing a plurality of reels of symbols in a starting set of reels, and one or more replacement reels of symbols; displaying on a display screen a depiction of at least a portion of each of the plurality of reels in the starting set; receiving, via a machine-user interface, user input indicating a wager; executing a first reel spin by modifying the depiction on the display screen to portray the plurality of reels in the starting set spinning, computing a first stopping position for each of the plurality of reels in the starting set, and then modifying the depiction on the display screen to portray each of the plurality of reels in the starting set stopped at its respective first stopping position; replacing the depiction on the display screen of at least one of the plurality of reels in the starting set with a depiction of at least a portion of at least one of the one or more replacement reels to form a modified set of reels depicted on the display screen, the modified set of reels comprising at least one reel from the starting set and at least one replacement reel; executing a second reel spin by modifying the depiction of the modified set of reels on the display screen to portray the reels in the modified set spinning, computing a second stopping position for each of the reels in the modified set, and then modifying the depiction on the display screen to portray each of the reels in the modified set stopped at its respective second stopping position; and determining a payout based on the second stopping positions of the reels in the modified set.

Another embodiment is directed to at least one processor-readable storage medium encoded with processor-executable instructions that, when executed, perform acts comprising: accessing, in one or more data structures, data representing a plurality of reels of symbols in a starting set of reels, and one or more replacement reels of symbols; displaying on a display screen a depiction of at least a portion of each of the plurality of reels in the starting set; receiving, via a machine-user interface, user input indicating a wager; executing a first reel spin by modifying the depiction on the display screen to portray the plurality of reels in the starting set spinning, computing a first stopping position for each of the plurality of reels in the starting set, and then modifying the depiction on the display screen to portray each of the plurality of reels in the starting set stopped at its respective first stopping position; replacing the depiction on the display screen of at least one of the plurality of reels in the starting set with a depiction of at least a portion of at least one of the one or more replacement reels to form a modified set of reels depicted on the display screen, the modified set of reels comprising at least one reel from the starting set and at least one replacement reel; executing a second reel spin by modifying the depiction of the modified set of reels on the display screen to portray the reels in the modified set spinning, computing a second stopping position for each of the reels in the modified set, and then modifying the depiction on the display screen to portray each of the reels in the modified set stopped at its respective second stopping position; and determining a payout based on the second stopping positions of the reels in the modified set.

Another embodiment is directed to a method, performed by a casino game server, of manipulating a display of reels in a reel-spinning wagering game, the method comprising: accessing, in one or more data structures stored in one or more processor-readable storage media, data representing a plurality of reels of symbols in a starting set of reels, and one or more replacement reels of symbols; transmitting to a video terminal machine data for creating a depiction of at least a portion of each of the plurality of reels in the starting set for display on the display screen of the video terminal machine; receiving, from the video terminal machine, user input indicating a wager inputted via a machine-user interface of the video terminal machine; and executing stored instructions via at least one processor to instruct the video terminal machine to execute a first reel spin by modifying the depiction on the display screen to portray the plurality of reels in the starting set spinning, compute a first stopping position for each of the plurality of reels in the starting set, and then instruct the video terminal machine to modify the depiction on the display screen to portray each of the plurality of reels in the starting set stopped at its respective first stopping position; instruct the video terminal machine to replace the depiction on the display screen of at least one of the plurality of reels in the starting set with a depiction of at least a portion of at least one of the one or more replacement reels to form a modified set of reels depicted on the display screen, the modified set of reels comprising at least one reel from the starting set and at least one replacement reel; instruct the video terminal machine to execute a second reel spin by modifying the depiction of the modified set of reels on the display screen to portray the reels in the modified set spinning, compute a second stopping position for each of the reels in the modified set, and then instruct the video terminal machine to modify the depiction on the display screen to portray each of the reels in the modified set stopped at its respective second stopping position; determine a payout based on the second stopping positions of the reels in the modified set; and instruct the video terminal machine to indicate the payout to the user.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view illustrating an exemplary cabinet housing a casino game machine in accordance with some embodiments;

FIG. 2 is a block diagram of a casino game machine linked to a casino's host system in accordance with some embodiments;

FIG. 3 is a block diagram illustrating an exemplary operating environment for a casino game machine in accordance with some embodiments;

FIGS. 4A-4J are screenshots illustrating exemplary manipulations of a display of reels in a reel-spinning wagering game in accordance with some embodiments;

FIG. 5 is a flowchart illustrating an exemplary method of manipulating a display of reels in a reel-spinning wagering game in accordance with some embodiments;

FIG. 6 is a flowchart illustrating another exemplary method of manipulating a display of reels in a reel-spinning wagering game in accordance with some embodiments; and

FIG. 7 is a schematic diagram of an exemplary computing environment in which some embodiments may be implemented.

### DETAILED DESCRIPTION

The inventor has appreciated that casino gambling is a risky and potentially discouraging activity for players, particularly if they realize that the odds in casino wagering games are typically set in favor of the house so that the casino can turn a profit. To overcome the natural tendency of many people to avoid risk, the inventor has recognized that it may be advantageous to design a casino game machine, such as an electronic gaming machine for a reel-spinning game (e.g., a slot machine), to include novel features that can add layers of excitement and anticipation to a player's gaming experience, thereby retaining and enhancing the player's interest in the game.

Accordingly, some embodiments described herein relate to techniques for manipulating a display of reels in a reel-spinning wagering game, in ways that may serve to build a player's interest in continuing to play the wagering game, such as by providing unique mechanisms for the player's expected winnings to increase at particular points in the gameplay. However, embodiments are not limited to any of these benefits, and it should be appreciated that some embodiments may not provide all or any of the above-discussed benefits.

In some embodiments, a memory (one or more processor-readable storage media) storing data and/or instructions used to present a reel-spinning game may include one or more data structures representing reels of symbols to be spun in the reel-spinning game. In some embodiments, the data may include symbols and probabilities for a starting set of reels that may be spun when a round of gameplay first commences. In some embodiments, the data may also include symbols and probabilities for one or more replacement reels, which can be used during gameplay to replace one or more of the reels currently in play. For example, in some embodiments, in response to the occurrence of a suitable trigger event during gameplay with the starting set of reels, one or more of the reels in the starting set may be removed from the game display and replaced with one or more of the replacement reels. In some embodiments, the symbols and probabilities in the replacement reels may be such that the modified set of reels formed by replacing one or more of the starting reels with one or more of the replacement reels has a higher expected payout than the starting set of reels did. Thus, in some embodiments, the player's interest in continuing to play the reel-spinning wagering game may be heightened by “trading up” one or more lower-paying reels for one or more higher-paying reels, thus increasing the player's winnings expectations. Additionally, in some embodiments, before a replacement reel is triggered to replace a reel currently in play, a preview depiction of the replacement reel may be displayed as an inactive reel. The inventor has appreciated that this may give the player an exciting sense of anticipation of an upcoming opportunity to increase the player's expected winnings, which may serve to motivate the player to continue playing the wagering game.

It should be appreciated that the foregoing description is by way of example only, and embodiments are not limited to providing any or all of the above-described functionality, although some embodiments may provide some or all of the functionality described herein.

The embodiments described herein can be implemented in any of numerous ways, and are not limited to any particular implementation techniques. Thus, while examples of specific implementation techniques are described below, it should be appreciated that the examples are provided merely for purposes of illustration, and that other implementations are possible.

One illustrative application for the techniques described herein is for use in a system for controlling a casino game machine. However, techniques described herein may be applied to any type of gaming device, including but not limited to a casino game machine (e.g., a slot machine), a PC, a laptop, a tablet, a smartphone, glasses with augmented reality technology, etc.

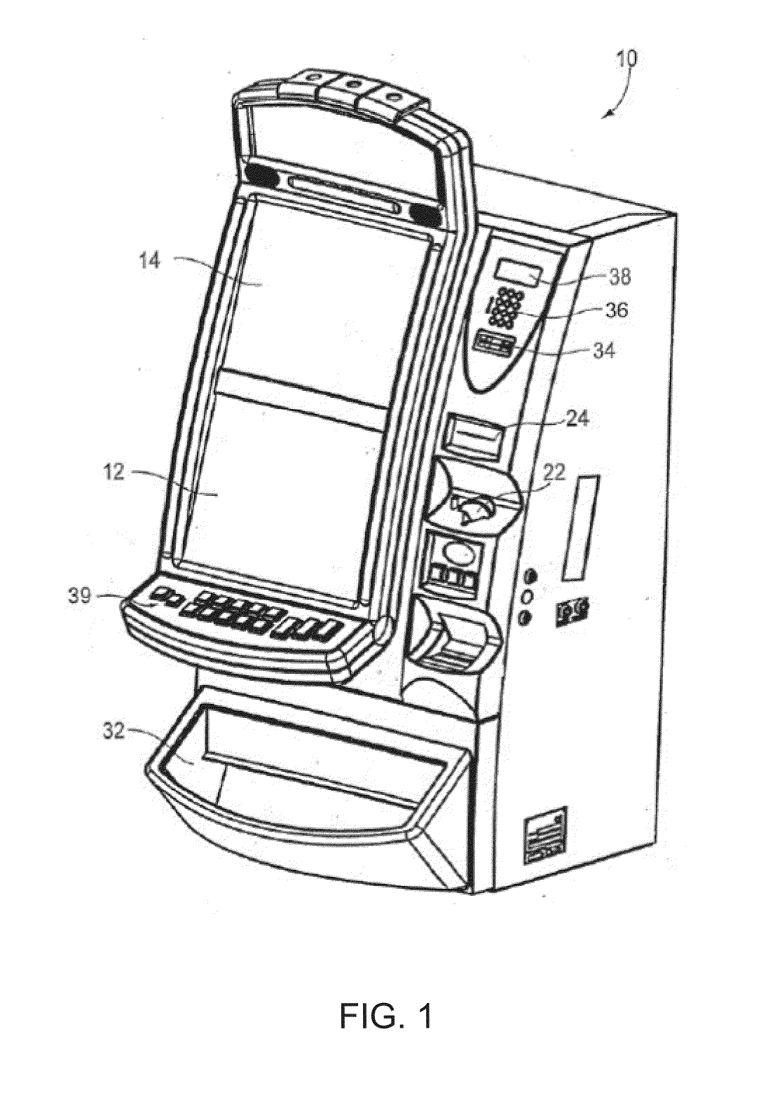

An exemplary cabinet 10 housing a casino game machine is illustrated in perspective view in FIG. 1. Exemplary cabinet 10, as depicted in FIG. 1, includes a display 12 that may be a thin film transistor (TFT) display, a liquid crystal display (LCD), a cathode ray tube (CRT) display, a light-emitting diode (LED) display, an organic LED (OLED) display, an autostereoscopic three dimensional (3D) display, or any other type of display. A second display 14 may provide game data or other information in addition to display 12. Display 14 may provide static information, such as an advertisement for the game, the rules of the game, pay tables, pay lines, and/or other information, and/or may even display the main game or a bonus game along with display 12. Alternatively, the area for display 14 may be a display glass for conveying information about the game. Display 12 may also include a camera for use, for example, in presenting an autostereoscopic 3D display.

Display 12 and/or display 14 may have a touch screen lamination that includes a transparent grid of conductors. A player touching the screen may change the capacitance between the conductors, and thereby the X-Y location of the touch on the screen may be determined. A processor within cabinet 10 may associate this X-Y location with a function to be performed. There may be an upper and lower multi-touch screen in accordance with some embodiments.

A coin slot 22 may accept coins or tokens in one or more denominations to generate credits within the casino game machine for playing games. An input slot 24 for an optical reader and printer may receive machine readable printed tickets and may output printed tickets for use in cashless gaming.

A coin tray 32 may receive coins or tokens from a hopper (not shown) upon a win or upon the player cashing out. However, in some embodiments, the casino game machine may not pay in cash, but may only issue a printed ticket for cashing in elsewhere. Alternatively, a stored value card may be loaded with credits based on a win, or may enable the assignment of credits to an account associated with a computer system, which may be a computer network-connected computer.

A card reader slot 34 may accept any of various types of cards, such as smart cards, magnetic strip cards, and/or other types of cards conveying machine readable information. The card reader may read the inserted card for player and/or credit information for cashless gaming. The card reader may read a magnetic code on a conventional player tracking card, where the code uniquely identifies the player to the host system. The code may be cross-referenced by the host system to any data related to the player, and such data may affect the games offered to the player by the casino game machine. The card reader may also include an optical reader and printer for reading and printing coded barcodes and other information on a paper ticket. A card may also include credentials that enable the host system to access one or more accounts associated with a user. The account may be debited based on wagers by a user and credited based on a win.

A keypad 36 may accept player input, such as a personal identification number (PIN) and/or any other player information. A display 38 above keypad 36 may display a menu for instructions and/or other information, and/or may provide visual feedback of the keys pressed. The keypad 36 may be an input device such as a touchscreen, or dynamic digital button panel, in accordance with some embodiments.

Player control buttons 39 may include any buttons and/or other controllers usable for the play of the particular game or games offered by the casino game machine, including, for example, a bet button, a repeat bet button, a spin reels (or play) button, a maximum bet button, a cash-out button, a display pay lines button, a display payout tables button, select icon buttons, and/or any other suitable button(s). In some embodiments, buttons 39 may be replaced by a touch screen with virtual buttons. In some embodiments, touchless control gesture functionality may replace or coexist with buttons 39.

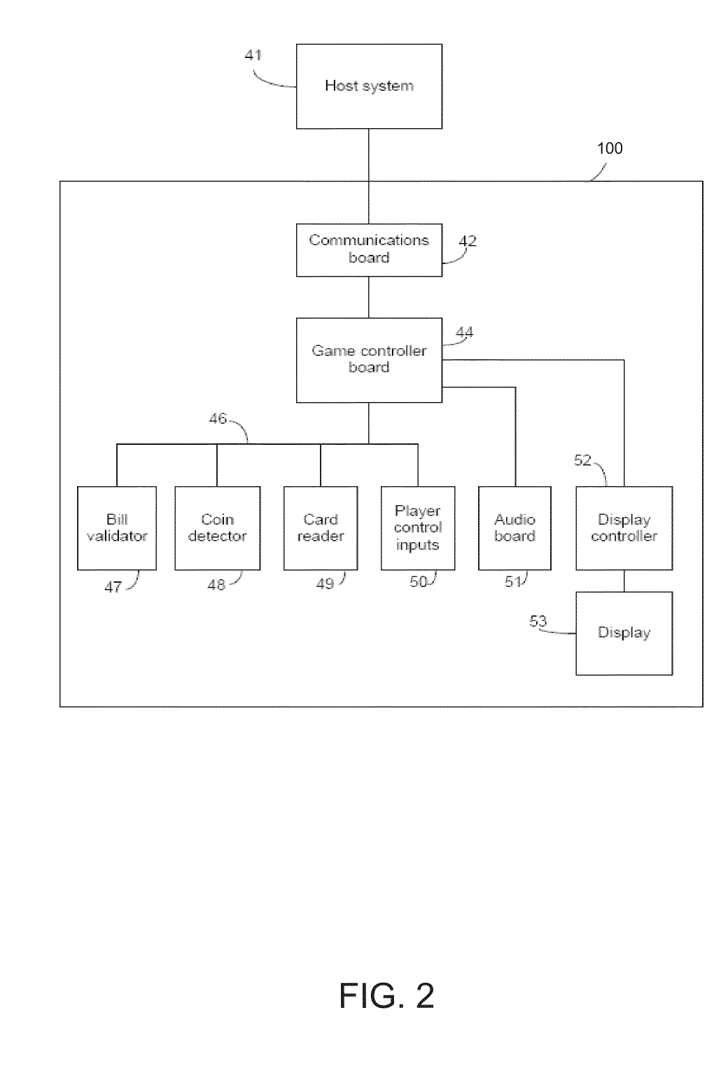

FIG. 2 is a block diagram of an exemplary casino game machine 100 (such as may be housed in exemplary cabinet 10) linked to a casino's host system 41. In the example shown, a communications board 42 may contain circuitry for coupling the casino game machine 100 to a local area network (LAN) and/or other type of network using any suitable protocol, such as the G2S protocols. Internet protocols are typically used for such communication under the G2S standard, incorporated herein by reference. Communications board 42 may transmit using a wireless transmitter, and/or may be directly connected to a network running throughout the casino floor. Communications board 42 may set up a communication link with a master controller and may buffer data between the network and game controller board 44. Communications board 42 may also communicate with a network server, such as in accordance with the G2S standard, for exchanging information to carry out embodiments described herein.

Game controller board 44 may contain memory and one or more processors for carrying out programs stored in the memory and for providing the information requested by the network. Game controller board 44 may execute programs stored in the memory and/or instructions received from host system 41 to carry out game routines.

Peripheral devices/boards may communicate with game controller board 44 via a bus 46 using, for example, an RS-232 interface. Such peripherals may include a bill validator 47, a coin detector 48, a smart card reader and/or other type of credit card reader 49, and/or player control inputs 50 (such as buttons 39 and/or a touch screen).

Game controller board 44 may also control one or more devices that produce the game output including audio and video output associated with a particular game that is presented to the user. For example, audio board 51 may convert coded signals into analog signals for driving speakers. Display controller 52 may convert coded signals into pixel signals for one or more displays 53 (e.g., display 12 and/or display 14). Display controller 52 and audio board 51 may be directly connected to parallel ports on game controller board 44. In some embodiments, the electronics on the various boards may be combined in any suitable way, such as onto a single board.

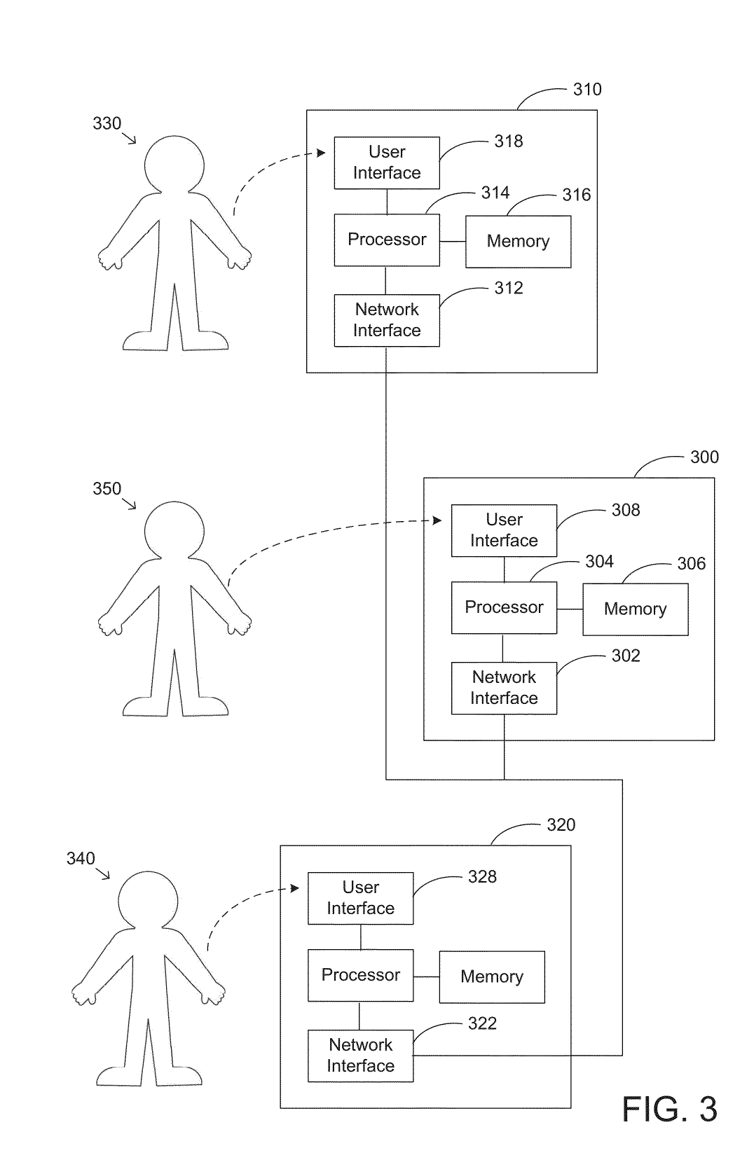

FIG. 3 illustrates an operating environment including an exemplary control system 310 that may be used in some embodiments to control a casino game machine, such as exemplary casino game machine 100, in one or more aspects. Control system 310 may be implemented in any suitable form, as embodiments are not limited in this respect. For example, control system 310 may be implemented as a single stand-alone machine, or may be implemented by multiple distributed machines that share processing tasks in any suitable manner. Control system 310 may be implemented as one or more computers; an example of a suitable computer is described below.

In some embodiments, control system 310 may include one or more tangible, non-transitory processor-readable storage devices storing processor-executable instructions, and one or more processors that execute the processor-executable instructions to perform the functions described herein. The storage devices may be implemented as computer-readable storage media (i.e., tangible, non-transitory computer-readable media) encoded with the processor-executable instructions; examples of suitable computer-readable storage media are discussed below. An example of a suitable storage medium is memory 316 depicted in FIG. 3, which is operatively connected to processor 314 for executing instructions stored in memory 316. In one example, processor 314 and memory 316 may be a processor and memory contained in game controller board 44, which may provide functionality for operating one or more games on casino game machine 100, in addition to providing control functionality described herein. In another example, processor 314 and/or memory 316 may be separate from game controller board 44 and may assert control signals upon game controller board 44 for affecting the operation of game controller board 44 in operating one or more games on casino game machine 100. When components of control system 310 are separate from components of casino game machine 100 described above, the components of control system 310 may be housed in any suitable location in any suitable configuration, within and/or attached to cabinet 10 and/or separated therefrom.

Exemplary control system 310 also includes a user interface component 318 configured to allow a user (player) 330 to interact with the casino game machine. User interface 318 may be implemented in any suitable form, as embodiments are not limited in this respect. In some embodiments, user interface 318 may configured to receive input from player 330 in any suitable form, such as by button, touchscreen, touchless control gesture, speech commands, etc., and may be configured to provide output to player 330 in any suitable form, such as audio output and/or visual output on a 2D or 3D display. In one exemplary embodiment, user interface 318 may include one or more components of casino game machine 100 housed in cabinet 10, such as player control inputs 50, audio board 51, display controller 52, and/or displays 53.

FIG. 3 further illustrates an example of a casino environment including a central control system 300 having an interface 302 for wired and/or wireless communication with local control systems for casino game machines 310 and 320 (and possibly other casino game machines) via their respective network interfaces 312 and 322. Exemplary central control system 300 includes one or more processors 304 and memory 306 (e.g., one or more processor-readable storage media) storing processor-executable instructions for causing processor 304 to perform functions such as transmitting control commands to casino game machines 310 and 320. For example, central control system 300 may, through execution by processor 304 of stored program instructions, stream game content casino game machines 310 and 320 and/or instruct casino game machines 310 and 320 to implement game adjustments selected by central control system 300 at times determined by central control system 300. In various embodiments, gaming functionality may be distributed between central control system 300 and game machine terminals such as 310 and 320 in any suitable way, making use of any suitable division of functionality. For instance, in some exemplary embodiments, central control system 300 may download games to game machine terminals 310 and/or 320, which may execute the game programs including performing random number generation for determining probabilistic symbol outcomes. In other exemplary embodiments, central control system 300 may perform random number generation and execute game programs for game machine terminals 310 and/or 320, which may merely display output received from central control system 300 and collect user input from users 330 and 340 via user interfaces 318 and 328 for transmission to central control system 300 via the network interfaces. In some embodiments, central control system 300 may have its own user interface 308 for interaction with a user 350. In some embodiments, central control system 300 may also be configured to function as a casino game machine with player interaction capabilities. However, in other embodiments, central control system 300 may simply function as a server providing functions to other casino game machines such as 310 and 320.

In some embodiments, one or more processors of a casino game machine and/or a central control system providing functionality to the casino game machine may execute stored instructions to present a reel-spinning game to a player via user interface components of the casino game machine. The form of play of the reel-spinning game may be to virtually spin a set of virtual reels having various symbols located at regularly spaced intervals (“stops”) on the reels. Portions of the virtual reels may be depicted on a display screen of the casino game machine as if the physical reels were placed side-by-side behind a window that leaves only a limited number of symbols on each reel visible through the window at any time. The player may place a wager on one or more paylines, each forming a pattern of symbol locations within the window on the reels. When the reels are spun, the symbols that appear in the window on the display when the reels stop spinning may be checked along each of the paylines on which a wager was placed, to determine whether any winning symbol combinations occur on those paylines to result in a payout to the player.

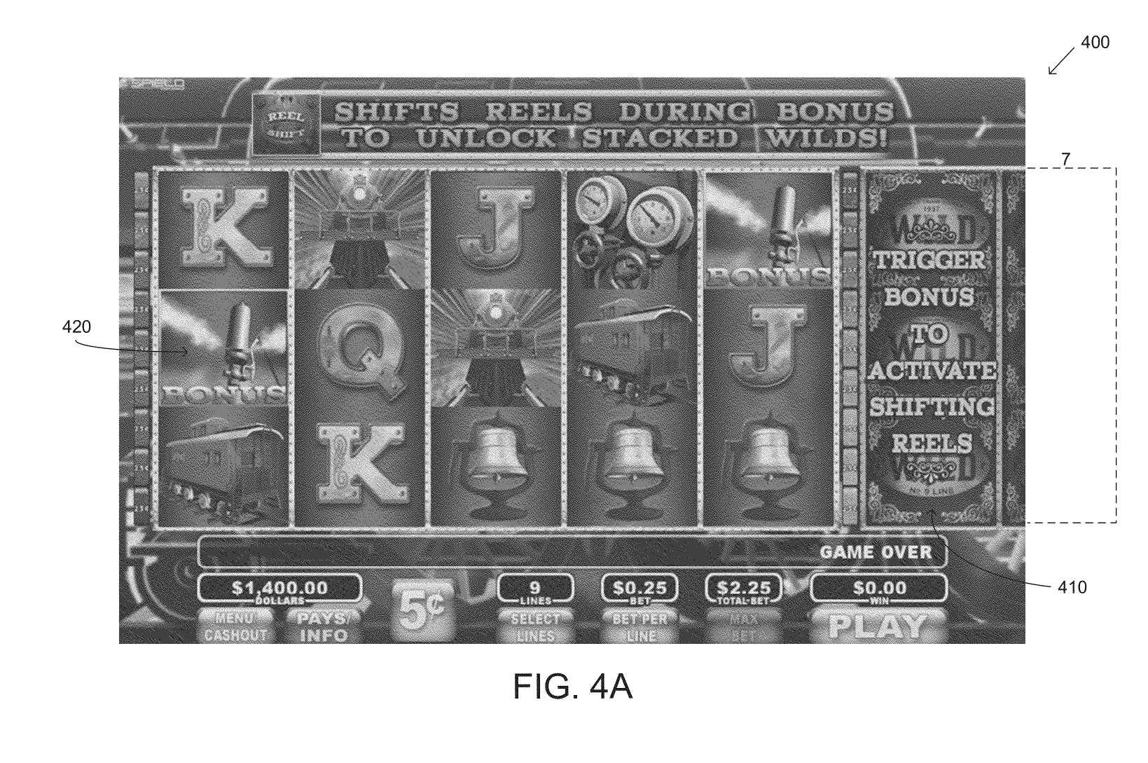

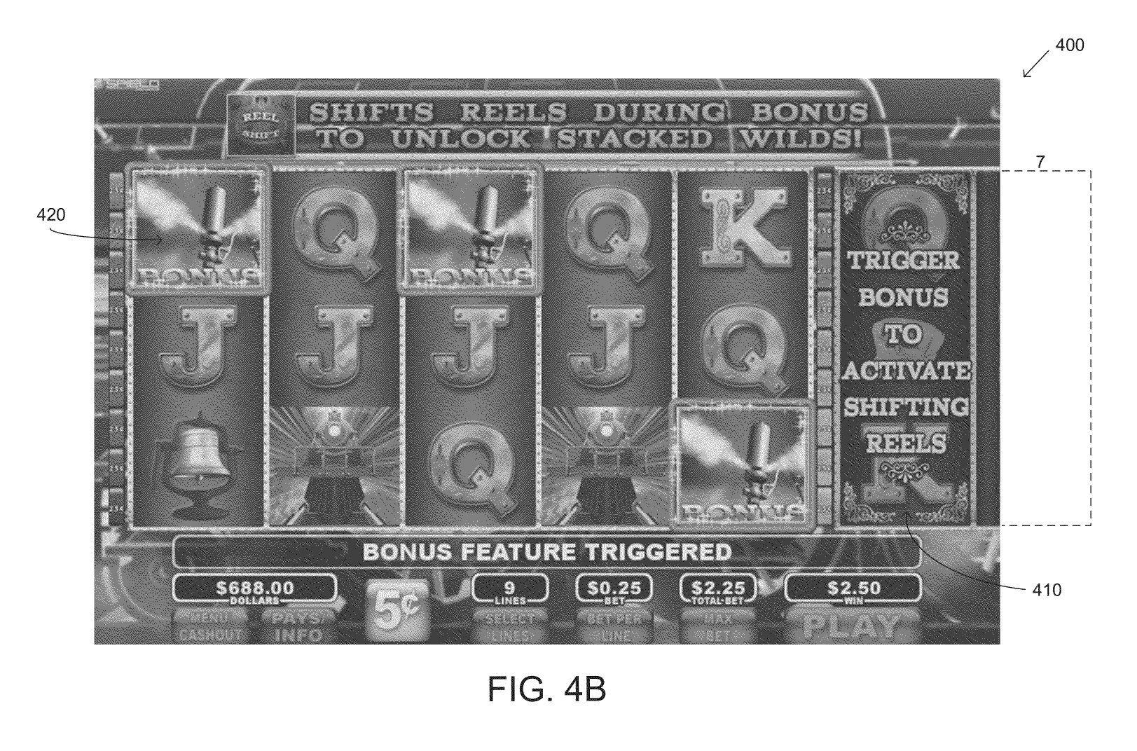

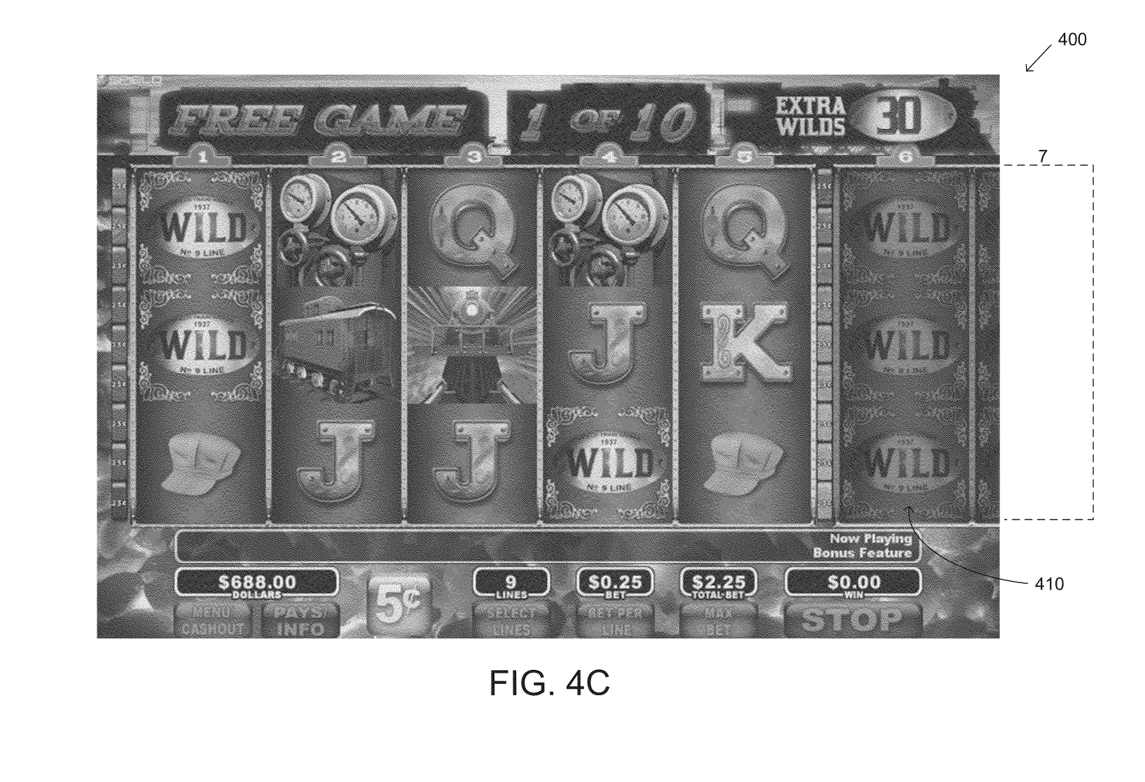

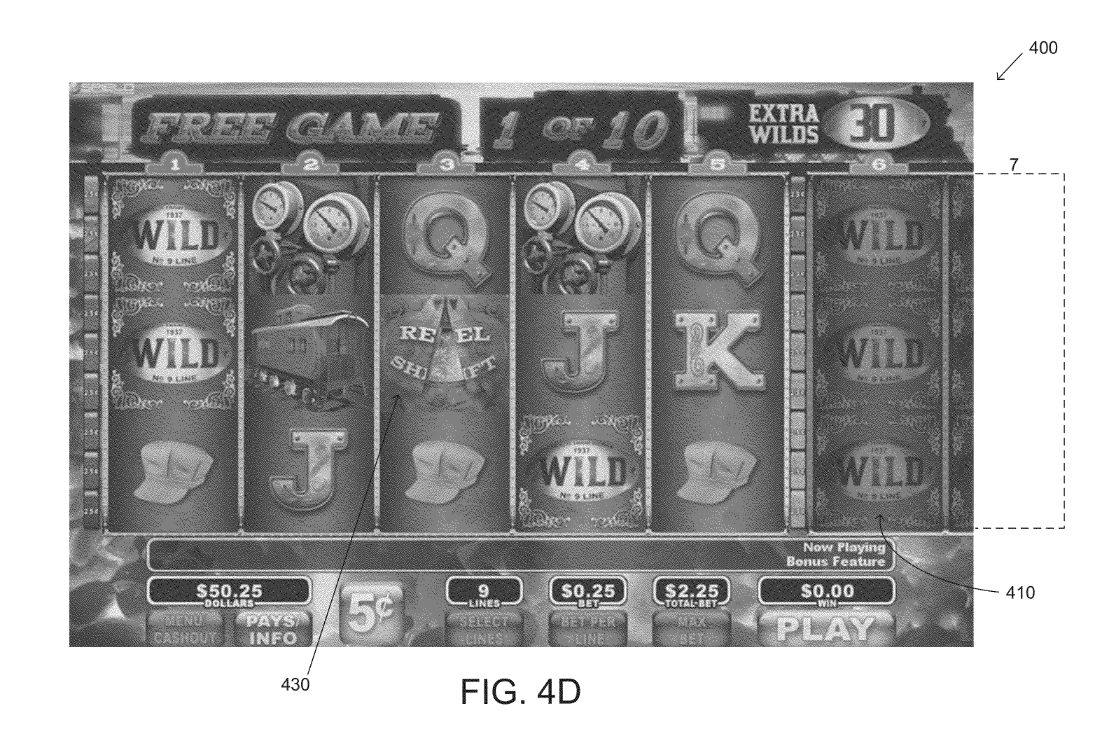

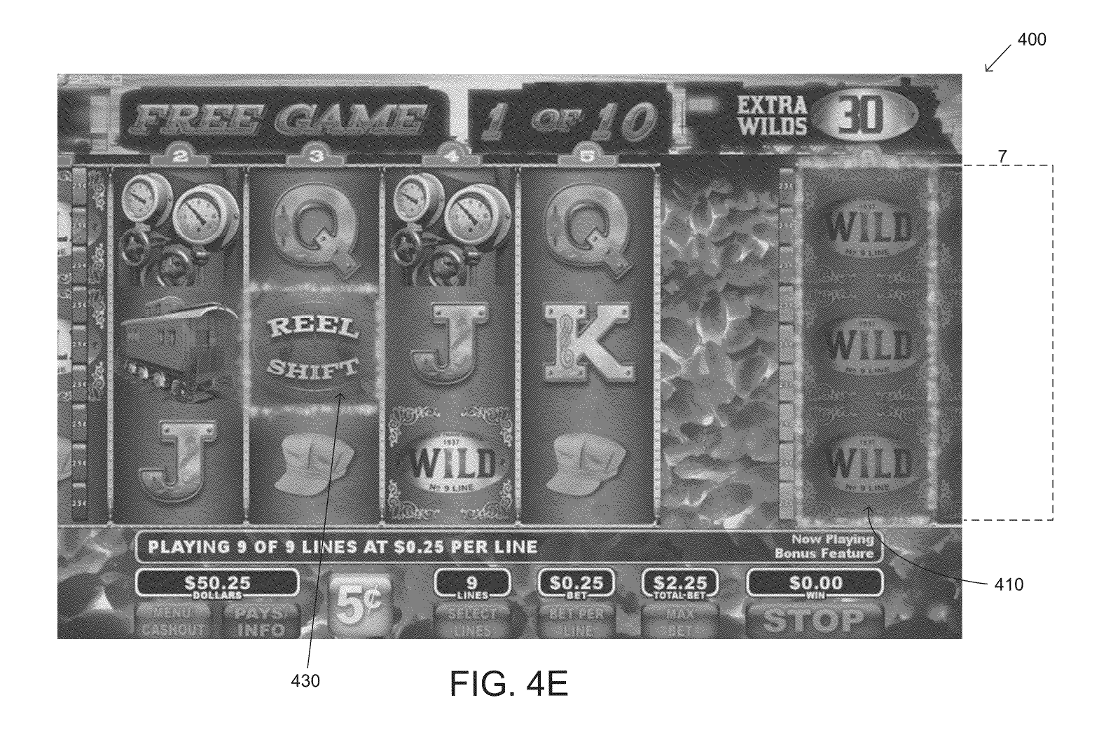

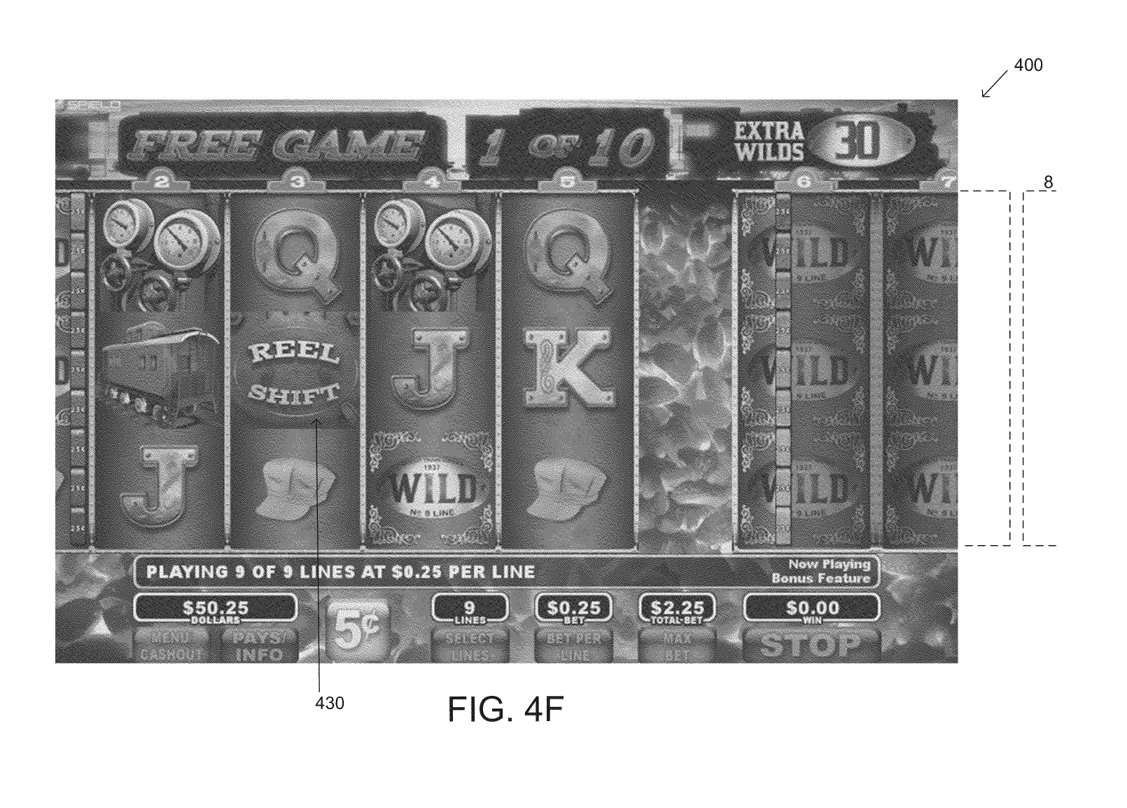

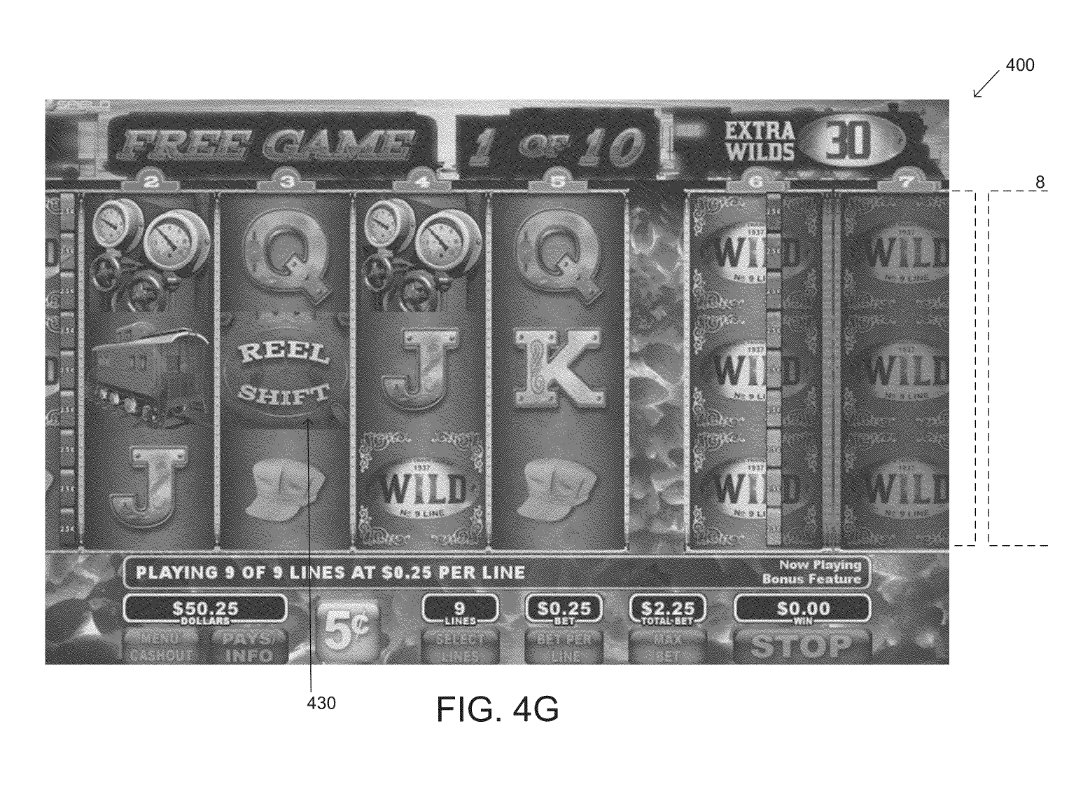

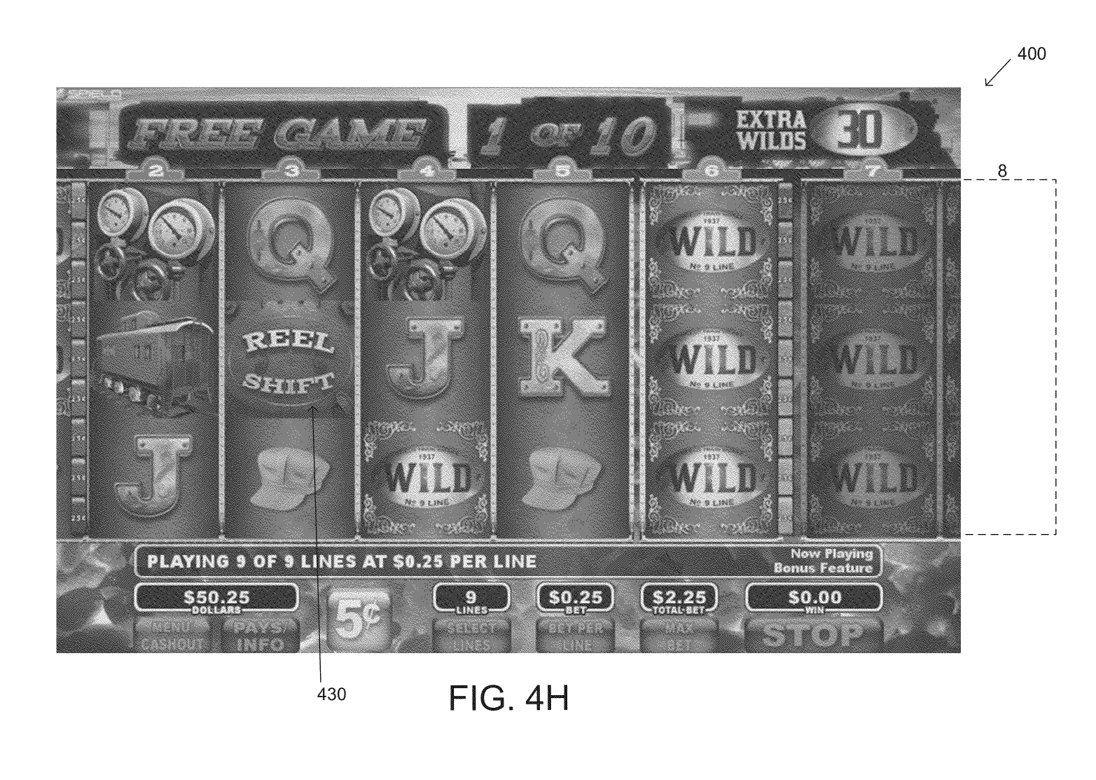

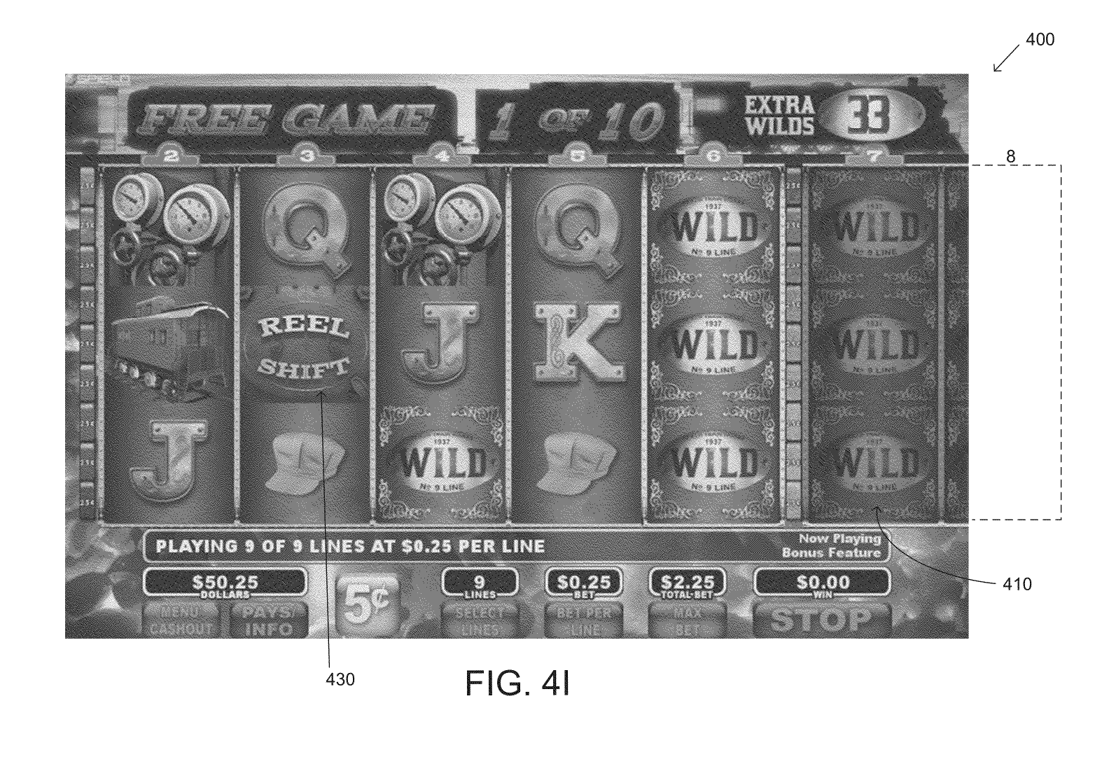

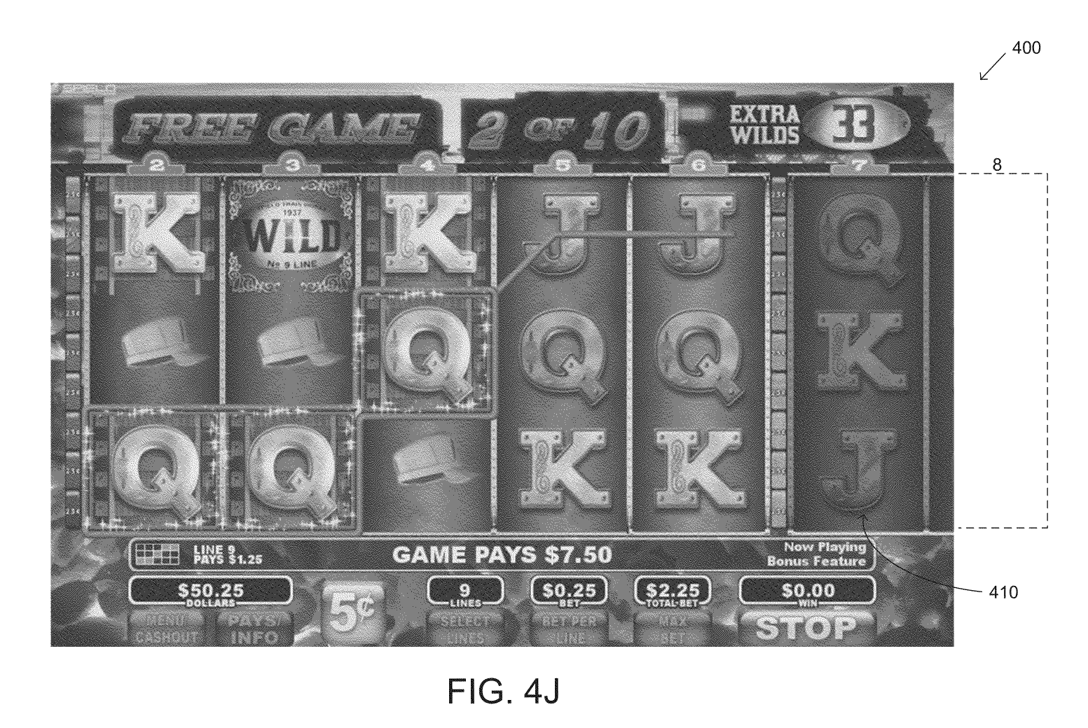

FIG. 4A illustrates an example depiction of a set of virtual reels on a display 400 of a reel-spinning game. In this example, there are five virtual reels in play, and they are depicted side-by-side in a window that exposes three symbols on each reel. In some embodiments, each reel may be represented in memory as a data structure including a list of the symbols on that reel along with any suitable data sufficient to determine which symbols will appear in the display window each time the reel is spun. For example, in some embodiments, a reel may be represented as a data structure including a list of all of the virtual stops on the reel, with an individual symbol assigned to each stop. When the virtual reel is spun, a system processor may execute a random number generation function to select one of the virtual stops at random, with each of the virtual stops having an equal probability of selection. One or more system processors may execute an animation routine to simulate the reel spinning on display 400, and then display the symbols listed in the data structure as occurring at the selected virtual stop when the animation concludes and the virtual reel stops spinning. In this case, the probability of a particular symbol appearing when the virtual reel is spun may be determined by the number of virtual stops on the reel occupied by that particular symbol. In another example, a reel may be represented in memory as a data structure listing each possible symbol only once, in association with a different occurrence probability for each symbol. For example, a reel could be defined to have the J symbol occur with 50% probability, the Q symbol with 30% probability, and the K symbol with 20% probability. When the reel is spun, a random number may be generated for each symbol position appearing on display 400 for that reel, and the symbol depicted for that position when the reel stops spinning may be selected by comparing the generated random number with the probabilities stored in the data structure for that reel. For example, if the random number is between 0 and 0.5, the J symbol may be displayed; if the random number is between 0.5 and 0.8, the Q symbol may be displayed; and if the random number is between 0.8 and 1, the K symbol may be displayed. Other examples are possible, and embodiments are not limited to any particular form of data structure for representing a virtual reel. In yet another example, the data structure may list, instead of individual symbols, all possible three-symbol sequences that could appear in the window on display 400 for that reel, along with an occurrence probability for each three-symbol sequence.

Typically in a reel-spinning game, the amount of winnings that a player receives as a payout resulting from a given reel spin depends on which paylines the player has placed wagers on, which symbols occur on those paylines when the reels stop spinning, and how much that particular combination or pattern of symbols pays. In some embodiments, the set of available paylines and the mappings from particular symbol combinations to particular payouts may be stored in memory in any suitable form of data structure, and the system may access these data at the conclusion of a reel spin to determine whether any winning combinations have occurred on paylines on which the player has wagered, and to compute the amount of any applicable payout to award to the player. The possible winning symbol combinations and the amounts of their corresponding payouts may also be provided to the player in the form of a pay table, to inform the player as to what symbol combinations and payouts the player could hope to achieve by continued play of the reel-spinning game. For instance, in one example the combination of three bell symbols occurring in a row could be defined in the pay table as a winning combination. Assuming the example configuration in FIG. 4A depicts the symbols that appeared at the conclusion of a reel spin, the combination of three bell symbols in a row occurs on the horizontal payline extending through the bottom symbol position of each reel. Thus, if the player had wagered on that bottom horizontal payline, the player would be awarded a payout as a result of this reel spin. The amount of the payout listed in the pay table and stored in memory for a particular winning symbol combination may be set in any suitable form, such as an absolute monetary amount, or a multiple of the player's wager on the payline. Likewise, the payout may be awarded to the player in any suitable way, such as by physically releasing currency and/or tokens from the casino game machine, by digitally adding the payout to any form of stored value card, by crediting the player's electronic account for access to the money elsewhere than the casino game machine, by authorizing the player for an equivalent number of free casino games, and/or in any other suitable way.

In some embodiments, when a display of a reel-spinning game normally depicts a window over a certain number of reels (say, five reels), the game system may have access to data representing not only those five reels, but also additional reels not originally displayed in the game window. In some embodiments, the stored data may represent a starting set of reels as well as one or more replacement reels, and opportunities may be provided during gameplay for one or more of the starting reels to be replaced by one or more of the replacement reels, e.g., to change the possible winning symbol combinations that could occur, or to change the probabilities of some winning symbol combinations occurring. In some embodiments, the reel replacement capability may only be provided during one or more bonus rounds of the game, in which case the starting set of reels for the bonus round may be the same or different reels from the main game reels in the main portion of the game. For example, in some embodiments, the stored data structure(s) representing the reels for the reel-spinning game may include data representing a main game set of reels, a different starting set of reels for the bonus (e.g., reels having different symbols and/or different symbol probabilities than the main game set of reels), and one or more replacement reels for the bonus. In other embodiments in which reel replacement only occurs during the bonus, the starting set of reels for the bonus may be the same as the main game reels, although in some embodiments certain symbols on the main game reels that trigger the bonus from the main game may be replaced by symbols that trigger reel replacement within the bonus round.

FIG. 4A illustrates an exemplary screenshot of a display 400 during the main portion of an exemplary reel-spinning game in accordance with some embodiments. In this example, the window for the five main game reels is slightly offset to the left of center on the display screen. This window is referred to herein as delineating the active reel positions, and the reels within the window are referred to as the active reels. In some embodiments, only symbols occurring on the current active reels can be used to win payouts. In the example of FIG. 4A, the offset of the active reel positions makes room for a preview position 410 in which an additional reel could be depicted. In the example of FIG. 4A, a message is displayed in preview position 410: “TRIGGER BONUS TO ACTIVATE SHIFTING REELS.” Although such a message is not required, in some embodiments it may serve to inform the player of the reel replacement opportunity that will be provided in the bonus round, and to increase the player's desire to continue playing (and wagering in) the main game for the chance to trigger a bonus round. Embodiments providing such a message are not limited to any particular choice of words or location of placement of the message within display 400 or elsewhere in the vicinity of the display screen.

Alternatively or additionally, in some embodiments an extra reel may be depicted in preview position 410, and in some embodiments the extra reel may be spun when the active reels are spun, to create anticipation in the player for what sorts of winning symbols might occur after the bonus round is triggered. Any suitable extra reel may be used in preview position 410 during the main portion of the game, such as one of the starting reels for the bonus, or one of the replacement reels, or an additional reel used only for the preview. In some embodiments, the preview depiction of the extra reel may include any suitable visual indicator(s) that the extra reel is currently inactive and not part of any paylines that could currently produce winnings; in the example of FIG. 4A, the extra reel in preview position 410 is darkened in relation to the active reels. In some embodiments, more than one extra reel may be depicted in preview positions, and in some embodiments, preview depictions of extra reels may be displayed such that they seem to extend in a sequence beyond the edge of the display screen. An example is illustrated in FIG. 4A, in which a portion of a seventh reel is depicted at the right-hand edge of display 400, in addition to the sixth reel in preview position 410, conveying the impression that the seventh reel (and potentially even more additional reels) extends beyond the edge of the display screen as indicated by the dotted line.

In some embodiments, the bonus round of the reel-spinning game may be triggered by any suitable bonus-triggering event from the main portion of the game, such as the occurrence of a particular symbol or combination of symbols. Bonus triggers are not necessarily limited to symbol occurrences, however; other examples of suitable bonus-triggering events may include reaching a particular amount of total winnings in the reel-spinning game, completing a particular number of reel spins in the main game, applying a bonus credit received from another game or a promotion in the casino, etc. In the example reel-spinning game illustrated in FIG. 4A, there is a particular symbol 420 that triggers a bonus round when at least three of that symbol occur within the game window at the conclusion of a reel spin. This exemplary bonus-triggering event is illustrated in FIG. 4B, which depicts display 400 after a reel spin in the main portion of the reel-spinning game, when three of bonus-triggering symbol 420 happen to have occurred in the game window on the active reels at the conclusion of the spin. In some embodiments, in response to the bonus-triggering event, the system's one or more processors may access the stored reel data to replace the depiction of the main game reels in the active reel positions on display 400 with a depiction of the starting set of reels for the bonus. For example, in some embodiments, the one or more processors may perform random number generation to select an initial virtual stop on each reel in the starting set, and may display a portion of each reel (e.g., the portion encompassing the symbols around the selected virtual stop) on display 400.

FIG. 4C illustrates an exemplary screenshot of the beginning of a bonus round in a reel-spinning game in accordance with some embodiments. In this example, the starting set of reels for the bonus round differ from the main game reels in part in that the bonus reels include WILD symbols, which can function as any other symbols to form winning symbol combinations on paylines in the bonus. However, this is merely an example and is not required in all embodiments. In some embodiments, as illustrated in this example, in addition to the starting set of reels in the active reel positions in the bonus, a preview depiction of the first replacement reel may be displayed in preview position 410. In this case, reels 1-5 form the starting set of reels, and a darkened preview of reel 6 (the first replacement reel) is depicted in preview position 410, followed by a portion of reel 7 (the second replacement reel) extending past the right-hand edge of the display screen. In this example, the message about triggering the bonus has been removed from preview position 410 now that the bonus has already been triggered, making the preview reel more visible and potentially increasing the player's awareness and sense of anticipation that reel 6 may be available to replace one of reels 1-5 upon the occurrence of a suitable reel replacement trigger. In some embodiments, the replacement reel in preview position 410 may be depicted spinning when the active reels are spun, e.g., to heighten the player's sense of anticipation as to the winning symbol combinations that could be achieved once the replacement reel is brought into active play.

In some embodiments, a replacement reel may be configured to create a higher payout expectation once it replaces one of the active reels in the game. This may be achieved in any suitable way. For instance, in the example depicted in FIG. 4C, each subsequent replacement reel includes more WILD symbols on more virtual stops, or a higher probability of producing a WILD symbol on a payline, than any previous reel it might replace. In this example, an indicator at the top right-hand side of display 400 informs the player that there are a total of 30 extra WILD symbols in the currently active reels, and this indicator may count up when a reel replacement occurs to supply a greater number of WILDs. Other ways of configuring replacement reels to produce higher payout expectations are possible as well. For instance, in another example, a replacement reel may have a higher probability of producing one or more non-WILD paying symbols on a payline than the previous reel it replaces. In any of these ways, a player may be enticed to continue playing the wagering game for the opportunity to trade up to higher-paying reels and increase his chances of winning bigger payouts. In some embodiments, the payout probabilities may be configured to maintain a desired overall payout percentage for the reel-spinning game. For example, in some embodiments, the symbol probabilities in the main game portion, the bonus trigger probabilities, and the symbol probabilities in the bonus portion may be set so that the average payout percentage for the reel-spinning game as a whole is a certain percentage (e.g., a percentage required by law), while the average expected payout per spin is higher in the bonus than in the main game portion.

In some embodiments, the player may be required to wager on one or more paylines in order to spin the reels in the bonus round. However, this is not required. In other embodiments, one or more free spins may be provided in the bonus round, and any payouts resulting from those free spins may be provided to the player without the player having wagered on those spins. In the example depicted in FIG. 4C, ten free spins are awarded at the beginning of the bonus round, and an indicator at the top of display 400 counts the number of free spins that have been used each time the reels are spun in the bonus. In some embodiments, the active paylines for the free spins may be limited to the paylines on which the player had wagered in the last reel spin in the main game portion before the bonus round was triggered. In other embodiments, one or more default paylines, such as all possible paylines in the game, may be active for producing winning symbol combinations in the bonus, regardless of which paylines had wagers in the main game portion.

In some embodiments, as the bonus round is played, one or more active reels may be replaced by one or more replacement reels in response to any suitable reel replacement trigger event. As with the bonus trigger, any suitable form of reel replacement trigger event may be used to cause a reel replacement. In some embodiments, reels in the bonus round (including the starting set of reels and the replacement reels) may include a reel replacement symbol having any suitable probability of occurrence, which probability may be the same or different across reels in the starting set and different replacement reels. In some embodiments, upon execution of a reel spin in the bonus round, a reel replacement may be triggered by the occurrence of the reel replacement symbol in any position in the game window, or by co-occurrence of a threshold number of reel replacement symbols within the game window, or by any suitable pattern of reel replacement symbols (e.g., on a payline), etc. An example of such a reel replacement trigger event is illustrated in FIG. 4D, which depicts the bonus round of FIG. 4C after the first reel spin, at which time in this example the reel replacement symbol 430 happens to have occurred in the middle position of active reel 3.

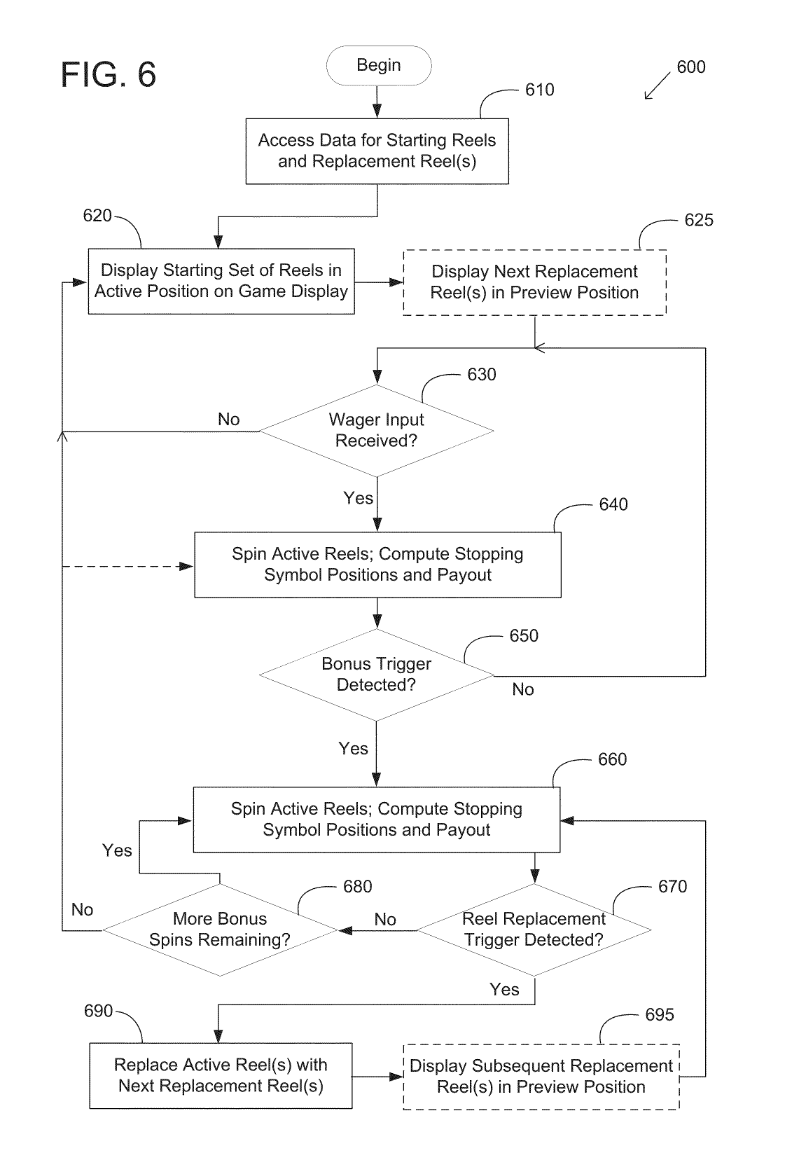

In some embodiments, in response to a reel replacement trigger event, such as occurrence of a reel replacement symbol upon a reel spin of the active set of reels in the bonus, the one or more processors may execute stored instructions to modify the game display by replacing the depiction of one or more of the reels in the starting set with one or more of the replacement reels, forming a modified set of active reels. In some embodiments, the number of reels replaced may be determined by the number of reel replacement symbols that occur at the conclusion of the reel spin. The reel replacement may be done in any suitable way, e.g., using any suitable animations to perform the reel replacement in an entertaining manner for the player. For instance, in some embodiments, the depiction of a reel in the starting set may be removed from its location on the display screen, and replaced at that location by the depiction of the replacement reel. In one example, a replacement reel may be animated as dropping down from above the reel being replaced (or from any other suitable direction), knocking the reel being replaced down off the bottom of the display (or in any other suitable direction) and taking its place. In other embodiments, the depiction of the entire starting set of reels may be shifted toward a particular edge of the display screen, resulting in the removal of the reel closest to that particular edge, and a depiction of the replacement reel may be inserted at the opposite side, farthest from that particular edge. FIGS. 4E-41 illustrate screenshots from an example of a suitable reel-shift animation; however, embodiments are not limited to this example, as a reel shift may be performed in any suitable way.

In the example shown in FIG. 4E, the starting set of reels 1-5 has been shifted to the left within the game window, exposing a space at the right-hand edge of the game window for a replacement reel, and reel 1 of the starting set has begun exiting the display. In FIG. 4F, the first replacement reel, reel 6, has begun shifting to the left into the exposed space in the active reel positions, and the next replacement reel, reel 7, has begun shifting to the left to take reel 6's place in the preview position. In FIGS. 4G and 4H, the shifting animation continues, until in FIG. 4I, replacement reel 6 has replaced reel 1 as an active reel (forming a modified set of active reels 2-6), reel 1 has been removed from the display, reel 7 now occupies preview position 410 as the next available replacement reel, and a portion of reel 8 is depicted on the display screen to hint to the player at the chain of subsequent reel replacement opportunities. In this example, reel 6 includes three more WILD symbols than reel 1 did, causing the modified set of active reels to have a higher payout expectation than the original starting set of reels. The player is informed of this enhanced payout expectation by the “EXTRA WILDS” indicator at the top right-hand corner of the display, which now reads 33 instead of the original 30 at the start of the bonus round.

In some embodiments, reel spins may continue to be executed within the bonus round as long as there are available free spins remaining, and subsequent reel replacements (such as reel shifts) may be executed in response to any reel replacement trigger events that occur in connection with those reel spins. In some embodiments, at the conclusion of each reel spin, the stopping positions of the active reels may determine whether any payout is rewarded, based on whether any winning combination of symbols occurs on an active payline at the conclusion of the reel spin. For example, FIG. 4J depicts exemplary game display 400 after the next free spin following the reel shift ending in FIG. 4I. At the conclusion of the reel spin in the example of FIG. 4J, a winning combination of three consecutive Q symbols appears on the payline connecting the bottom symbols of the left two active reels, the center symbol of the center active reel, and the top symbols of the right two active reels. A visual indicator of the payline and the winning combination is provided in the exemplary display of FIG. 4J, and the appropriate payout for that symbol combination is computed by the one or more processors and provided to the player in any suitable way (non-limiting examples of which are given above).

Additionally, in the example of FIG. 4J, the indicator at the top of display 400 has counted up to “FREE GAME 2 OF 10,” to inform the player that the second of the ten free spins is currently in play. In some embodiments, when all of the free spins have been used, the reel-spinning game may revert to the main game, in which the player must wager on each reel spin in some embodiments. In some embodiments, upon returning to the main game portion, the active reels may revert to the main game reels originally in play before the bonus round was triggered. However, in other embodiments, the currently active reels from the end of the bonus round may be retained upon returning to the main game, or any other suitable set of reels may be used when returning to the main game. In some embodiments, a mechanism may be provided in the bonus round to extend the number of free spins available, such as a “+1 free game” symbol that may appear on reels in the bonus round with any suitable probability to trigger the awarding of an additional free spin. Additionally, in some embodiments, when a reel replacement trigger event occurs, the reel spin upon which the reel replacement trigger event occurred may not be counted against the number of free spins available in the bonus.

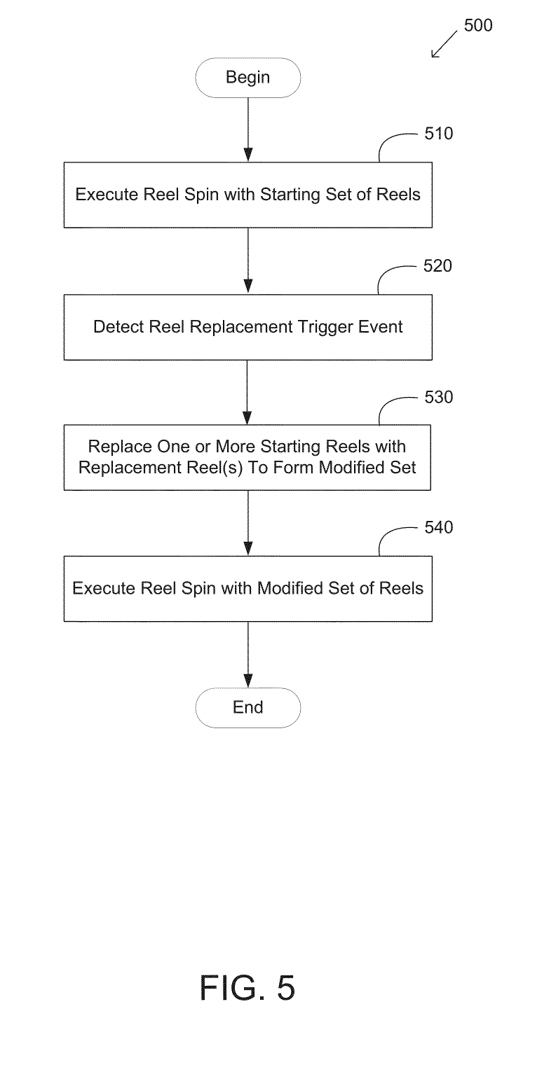

It should be appreciated from the foregoing that one embodiment is directed to a method 500 for manipulating a display of reels in a reel-spinning wagering game, as illustrated in FIG. 5. Method 500 may be performed, for example, by one or more processors of a control system such as control system 310 or control system 300, although other implementations are possible, as method 500 is not limited in this respect. Method 500 begins at act 510, at which a reel spin may be executed with a starting set of reels. At act 520, a reel replacement trigger event may be detected, and in response, at act 530 one or more of the reels in the starting set may be replaced with one or more replacement reels to form a modified set of reels including at least one reel from the starting set and at least one replacement reel. Method 500 ends at act 540, at which a reel spin may be executed with the modified set of reels formed by the replacement.

It should be further appreciated from the foregoing that another embodiment is directed to a method 600 for operating a reel-spinning wagering game and manipulating a display of reels in the reel-spinning wagering game. Method 600 may be performed, for example, by one or more processors of a control system such as control system 310 or control system 300, although other implementations are possible, as method 600 is not limited in this respect. Method 600 begins at act 610, at which data representing a plurality of reels of symbols in a starting set of reels, and data representing one or more replacement reels, may be accessed in one or more data structures stored in one or more processor-readable storage media. In the exemplary embodiment of method 600, the same starting set of reels is used for both a main portion and a bonus portion of the reel-spinning game. However, as discussed above, embodiments are not limited to using the same starting set of reels in both portions of the game, and some embodiments may use a different starting set of reels for the bonus than for the main game portion.

At act 620 of exemplary method 600, a depiction of at least a portion of each of the plurality of reels in the starting set may be displayed on a display screen in the active position on the game display. At act 625, optionally, the next replacement reel(s) (at this point, the first replacement reel, and optionally any portion of one or more subsequent replacement reels) may be displayed in a preview position on the display. At act 630, the system may wait until user input indicating a wager is received via a machine-user interface. Until such a wager input is received, method 600 may loop back through acts 620 and 625, maintaining the static display of the reels. User input indicating a wager may be made in any suitable form, as embodiments are not limited in this respect, and may not always require the user to input a “new” wager. For example, in some embodiments, it may be assumed that the user's wager from the previous spin is to be repeated on the next spin unless the user indicates that it is to be changed, and the wager-indicating user input for the next spin may simply be a press of a “play” or “spin” button to indicate the same wager as for the previous spin. At act 640, in response to receiving the wager-indicating user input, a reel spin of the active reels may be executed by modifying the display screen to portray the plurality of reels in the starting set spinning, computing a stopping symbol position for each of the plurality of reels in the starting set, and then modifying the depiction on the display screen to portray each of the plurality of reels in the starting set stopped at its respective stopping symbol position. Any applicable payout may also be computed based on the stopping symbol positions of the active reels.

At act 650, a determination may be made as to whether a bonus-triggering event is detected in connection with the reel spin of act 640. Examples of suitable bonus-triggering events are given above. If a bonus-triggering event is not detected, method 600 may loop back to act 630 to await a wager-indicating user input before executing the next reel spin in the main portion of the game. If a bonus-triggering event is detected at act 650, then one or more bonus spins (e.g., free spins) may be allocated, and the first bonus spin may be executed at act 660. The reel spin may include executing stored instructions via at least one processor to modify the depiction on the display screen to portray the active reels spinning, compute a stopping symbol position for each of the active reels, and then modify the depiction on the display screen to portray the active reels stopped at their respective stopping symbol positions. Any applicable payout may also be determined based on the stopping symbol positions of the active reels.

At act 670, a determination may be made as to whether a reel replacement triggering event is detected in connection with the reel spin of act 660. Examples of suitable reel replacement triggering events are given above. If a reel replacement triggering event is not detected, method 600 may continue to act 680, where a determination may be made as to whether there are more bonus spins remaining. If yes, then method 600 may loop bock to act 660, at which the next bonus spin may be executed. If not, then method 600 may exit the bonus portion of the reel-spinning game and loop back to act 620, at which the active reels for the main portion of the reel-spinning game may be displayed, and wager-indicating user input may be awaited.

If a reel replacement triggering event is detected at act 670, then method 600 may proceed to act 690, at which the depiction on the display screen of at least one of the currently active reels may be replaced with a depiction of at least a portion of at least one of the one or more replacement reels (e.g., the next replacement reel(s) from the preview position) to form a modified set of reels depicted on the display screen as the active reels. At act 695, optionally, one or more subsequent replacement reels may then be displayed in the preview position. Method 600 may then loop back to act 660, at which the next bonus reel spin may be executed using the modified set of reels.

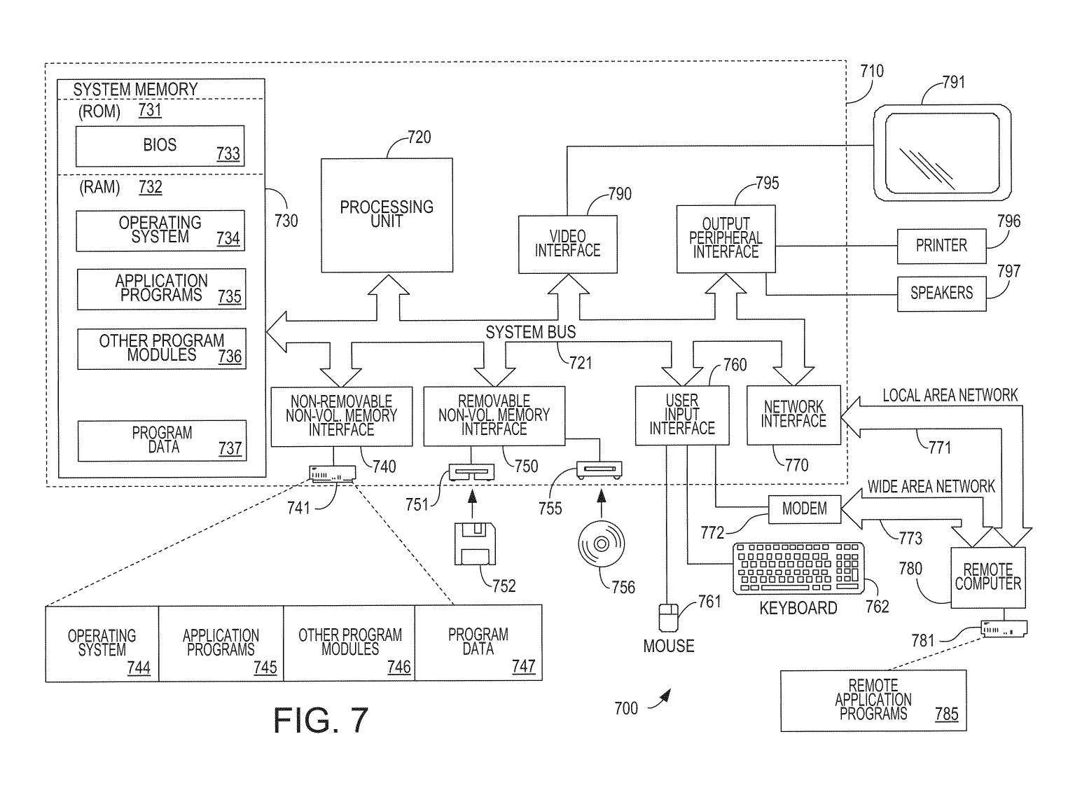

FIG. 7 illustrates an example of a suitable computing system environment 700 in which some embodiments may be implemented. This computing system may be representative of a computing system that allows a suitable control system to implement the described techniques. However, it should be appreciated that the computing system environment 700 is only one example of a suitable computing environment and is not intended to suggest any limitation as to the scope of use or functionality of the described embodiments. Neither should the computing environment 700 be interpreted as having any dependency or requirement relating to any one or combination of components illustrated in the exemplary operating environment 700.

The embodiments are operational with numerous other general purpose or special purpose computing system environments or configurations. Examples of well-known computing systems, environments, and/or configurations that may be suitable for use with the described techniques include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc., that perform particular tasks or implement particular abstract data types. The embodiments may also be practiced in distributed computing environments where tasks are performed by remote processing devices that are linked through a communications network. In a distributed computing environment, program modules may be located in both local and remote computer storage media including memory storage devices.

With reference to FIG. 7, an exemplary system for implementing the described techniques includes a general purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7 provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 710 through input devices such as a keyboard 762 and pointing device 761, commonly referred to as a mouse, trackball or touch pad. Other input devices (not shown) may include a microphone, joystick, game pad, satellite dish, scanner, touchscreen, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 795.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation comprises at least one processor-readable storage medium (i.e., at least one tangible, non-transitory processor-readable medium, e.g., a computer memory (e.g., hard drive, flash memory, processor working memory, etc.), a floppy disk, an optical disc, a magnetic tape, or other tangible, non-transitory processor-readable medium) encoded with a computer program (i.e., a plurality of instructions), which, when executed on one or more processors, performs at least the above-discussed functions. The processor-readable storage medium can be transportable such that the program stored thereon can be loaded onto any computer resource to implement functionality discussed herein. In addition, it should be appreciated that the reference to a computer program which, when executed, performs above-discussed functions, is not limited to an application program running on a host computer. Rather, the term “computer program” is used herein in a generic sense to reference any type of computer code (e.g., software or microcode) that can be employed to program one or more processors to implement above-discussed functionality.

The phraseology and terminology used herein is for the purpose of description and should not be regarded as limiting. The use of “including,” “comprising,” “having,” “containing,” “involving,” and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described several embodiments of the invention, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of manipulating a display of reels in a reel-spinning wagering game, the method comprising:
accessing, in one or more data structures stored in one or more processor-readable storage media, data representing a plurality of reels of symbols in a starting set of reels, and one or more replacement reels of symbols;
displaying on a display screen a depiction of at least a portion of each of the plurality of reels in the starting set;
receiving, via a machine-user interface, user input indicating a wager; and
executing stored instructions via at least one processor to:
execute a first reel spin by modifying the depiction on the display screen to portray the plurality of reels in the starting set spinning, computing a first stopping position for each of the plurality of reels in the starting set, and then modifying the depiction on the display screen to portray each of the plurality of reels in the starting set stopped at its respective first stopping position;
replace the depiction on the display screen of at least one of the plurality of reels in the starting set with a depiction of at least a portion of at least one of the one or more replacement reels to form a modified set of reels depicted on the display screen, the modified set of reels comprising at least one reel from the starting set and at least one replacement reel;
execute a second reel spin by modifying the depiction of the modified set of reels on the display screen to portray the reels in the modified set spinning, computing a second stopping position for each of the reels in the modified set, and then modifying the depiction on the display screen to portray each of the reels in the modified set stopped at its respective second stopping position; and
determine a payout based on the second stopping positions of the reels in the modified set.

2. The method of claim 1, wherein forming the modified set of reels comprises shifting the depiction of the starting set of reels toward a particular edge of the display screen, removing from the depiction at least one of the reels in the starting set that is closest to the particular edge, and inserting the depiction of the at least one replacement reel farthest from the particular edge.

3. The method of claim 1, wherein forming the modified set of reels comprises removing the depiction of the at least one of the reels in the starting set from a particular location on the display screen, and inserting the depiction of the at least one replacement reel at the particular location.

4. The method of claim 1, wherein the modified set of reels is formed in response to a reel replacement trigger event occurring in connection with a reel spin of the starting set of reels.

5. The method of claim 4, wherein the reel replacement trigger event comprises occurrence of a reel replacement symbol upon the reel spin of the starting set of reels.

6. The method of claim 5, wherein forming the modified set of reels comprises determining a number of replacement reels to include in the modified set of reels based on a number of reel replacement symbols occurring upon the reel spin of the starting set of reels.

7. The method of claim 1, wherein the modified set of reels has a higher expected payout than the starting set of reels.

8. The method of claim 7, wherein the at least one replacement reel includes more wild symbols than any of the plurality of reels in the starting set.

9. The method of claim 1, further comprising displaying, during the first reel spin, a preview depiction of at least a first replacement reel of the one or more replacement reels.

10. The method of claim 9, wherein the preview depiction comprises one or more visual indicators that the first replacement reel is currently inactive.

11. The method of claim 10, wherein the one or more visual indicators comprise a darkening of the preview depiction of the first replacement reel relative to the depiction of the starting set of reels.

12. The method of claim 9, further comprising modifying the preview depiction during the first reel spin to portray the first replacement reel spinning along with the plurality of reels in the starting set.

13. The method of claim 1, wherein the modified set of reels is formed in a bonus portion of a reel spinning game, and not in a non-bonus portion of the reel spinning game.

14. The method of claim 13, further comprising continuing gameplay with the modified set of reels after termination of the bonus portion of the reel spinning game.

15. The method of claim 13, further comprising reverting to the starting set of reels after termination of the bonus portion of the reel spinning game.

16. Apparatus comprising:
at least one processor; and
at least one processor-readable storage medium storing processor-executable instructions that, when executed by the at least one processor, cause the at least one processor to perform acts comprising:
accessing, in one or more data structures, data representing a plurality of reels of symbols in a starting set of reels, and one or more replacement reels of symbols;
displaying on a display screen a depiction of at least a portion of each of the plurality of reels in the starting set;
receiving, via a machine-user interface, user input indicating a wager;
executing a first reel spin by modifying the depiction on the display screen to portray the plurality of reels in the starting set spinning, computing a first stopping position for each of the plurality of reels in the starting set, and then modifying the depiction on the display screen to portray each of the plurality of reels in the starting set stopped at its respective first stopping position;
replacing the depiction on the display screen of at least one of the plurality of reels in the starting set with a depiction of at least a portion of at least one of the one or more replacement reels to form a modified set of reels depicted on the display screen, the modified set of reels comprising at least one reel from the starting set and at least one replacement reel;
executing a second reel spin by modifying the depiction of the modified set of reels on the display screen to portray the reels in the modified set spinning, computing a second stopping position for each of the reels in the modified set, and then modifying the depiction on the display screen to portray each of the reels in the modified set stopped at its respective second stopping position; and
determining a payout based on the second stopping positions of the reels in the modified set.

17. The apparatus of claim 16, wherein forming the modified set of reels comprises shifting the depiction of the starting set of reels toward a particular edge of the display screen, removing from the depiction at least one of the reels in the starting set that is closest to the particular edge, and inserting the depiction of the at least one replacement reel farthest from the particular edge.

18. The apparatus of claim 16, wherein forming the modified set of reels comprises removing the depiction of the at least one of the reels in the starting set from a particular location on the display screen, and inserting the depiction of the at least one replacement reel at the particular location.

19. The apparatus of claim 16, wherein the modified set of reels is formed in response to a reel replacement trigger event occurring in connection with a reel spin of the starting set of reels.

20. The apparatus of claim 19, wherein the reel replacement trigger event comprises occurrence of a reel replacement symbol upon the reel spin of the starting set of reels.

21. The apparatus of claim 20, wherein forming the modified set of reels comprises determining a number of replacement reels to include in the modified set of reels based on a number of reel replacement symbols occurring upon the reel spin of the starting set of reels.

22. The apparatus of claim 16, wherein the modified set of reels has a higher expected payout than the starting set of reels.

23. The apparatus of claim 22, wherein the at least one replacement reel includes more wild symbols than any of the plurality of reels in the starting set.

24. The apparatus of claim 16, wherein the acts further comprise displaying, during the first reel spin, a preview depiction of at least a first replacement reel of the one or more replacement reels.

25. The apparatus of claim 24, wherein the preview depiction comprises one or more visual indicators that the first replacement reel is currently inactive.

26. The apparatus of claim 25, wherein the one or more visual indicators comprise a darkening of the preview depiction of the first replacement reel relative to the depiction of the starting set of reels.

27. The apparatus of claim 24, wherein the acts further comprise modifying the preview depiction during the first reel spin to portray the first replacement reel spinning along with the plurality of reels in the starting set.

28. The apparatus of claim 16, wherein the modified set of reels is formed in a bonus portion of a reel spinning game, and not in a non-bonus portion of the reel spinning game.

29. The apparatus of claim 28, wherein the acts further comprise continuing gameplay with the modified set of reels after termination of the bonus portion of the reel spinning game.

30. The apparatus of claim 28, wherein the acts further comprise reverting to the starting set of reels after termination of the bonus portion of the reel spinning game.

31. At least one processor-readable storage medium encoded with processor-executable instructions that, when executed, perform acts comprising:
accessing, in one or more data structures, data representing a plurality of reels of symbols in a starting set of reels, and one or more replacement reels of symbols;
displaying on a display screen a depiction of at least a portion of each of the plurality of reels in the starting set;
receiving, via a machine-user interface, user input indicating a wager;
executing a first reel spin by modifying the depiction on the display screen to portray the plurality of reels in the starting set spinning, computing a first stopping position for each of the plurality of reels in the starting set, and then modifying the depiction on the display screen to portray each of the plurality of reels in the starting set stopped at its respective first stopping position;
replacing the depiction on the display screen of at least one of the plurality of reels in the starting set with a depiction of at least a portion of at least one of the one or more replacement reels to form a modified set of reels depicted on the display screen, the modified set of reels comprising at least one reel from the starting set and at least one replacement reel;
executing a second reel spin by modifying the depiction of the modified set of reels on the display screen to portray the reels in the modified set spinning, computing a second stopping position for each of the reels in the modified set, and then modifying the depiction on the display screen to portray each of the reels in the modified set stopped at its respective second stopping position; and
determining a payout based on the second stopping positions of the reels in the modified set.

32. The at least one processor-readable storage medium of claim 31, wherein forming the modified set of reels comprises shifting the depiction of the starting set of reels toward a particular edge of the display screen, removing from the depiction at least one of the reels in the starting set that is closest to the particular edge, and inserting the depiction of the at least one replacement reel farthest from the particular edge.

33. The at least one processor-readable storage medium of claim 31, wherein forming the modified set of reels comprises removing the depiction of the at least one of the reels in the starting set from a particular location on the display screen, and inserting the depiction of the at least one replacement reel at the particular location.

34. The at least one processor-readable storage medium of claim 31, wherein the modified set of reels is formed in response to a reel replacement trigger event occurring in connection with a reel spin of the starting set of reels.

35. The at least one processor-readable storage medium of claim 34, wherein the reel replacement trigger event comprises occurrence of a reel replacement symbol upon the reel spin of the starting set of reels.

36. The at least one processor-readable storage medium of claim 35, wherein forming the modified set of reels comprises determining a number of replacement reels to include in the modified set of reels based on a number of reel replacement symbols occurring upon the reel spin of the starting set of reels.

37. The at least one processor-readable storage medium of claim 31, wherein the modified set of reels has a higher expected payout than the starting set of reels.

38. The at least one processor-readable storage medium of claim 37, wherein the at least one replacement reel includes more wild symbols than any of the plurality of reels in the starting set.

39. The at least one processor-readable storage medium of claim 31, wherein the acts further comprise displaying, during the first reel spin, a preview depiction of at least a first replacement reel of the one or more replacement reels.

40. The at least one processor-readable storage medium of claim 39, wherein the preview depiction comprises one or more visual indicators that the first replacement reel is currently inactive.

41. The at least one processor-readable storage medium of claim 40, wherein the one or more visual indicators comprise a darkening of the preview depiction of the first replacement reel relative to the depiction of the starting set of reels.

42. The at least one processor-readable storage medium of claim 39, wherein the acts further comprise modifying the preview depiction during the first reel spin to portray the first replacement reel spinning along with the plurality of reels in the starting set.

43. The at least one processor-readable storage medium of claim 31, wherein the modified set of reels is formed in a bonus portion of a reel spinning game, and not in a non-bonus portion of the reel spinning game.

44. The at least one processor-readable storage medium of claim 43, wherein the acts further comprise continuing gameplay with the modified set of reels after termination of the bonus portion of the reel spinning game.

45. The at least one processor-readable storage medium of claim 43, wherein the acts further comprise reverting to the starting set of reels after termination of the bonus portion of the reel spinning game.

46. A method, performed by a casino game server, of manipulating a display of reels in a reel-spinning wagering game, the method comprising:
accessing, in one or more data structures stored in one or more processor-readable storage media, data representing a plurality of reels of symbols in a starting set of reels, and one or more replacement reels of symbols;
transmitting to a video terminal machine data for creating a depiction of at least a portion of each of the plurality of reels in the starting set for display on the display screen of the video terminal machine;
receiving, from the video terminal machine, user input indicating a wager inputted via a machine-user interface of the video terminal machine; and
executing stored instructions via at least one processor to:
instruct the video terminal machine to execute a first reel spin by modifying the depiction on the display screen to portray the plurality of reels in the starting set spinning, compute a first stopping position for each of the plurality of reels in the starting set, and then instruct the video terminal machine to modify the depiction on the display screen to portray each of the plurality of reels in the starting set stopped at its respective first stopping position;
instruct the video terminal machine to replace the depiction on the display screen of at least one of the plurality of reels in the starting set with a depiction of at least a portion of at least one of the one or more replacement reels to form a modified set of reels depicted on the display screen, the modified set of reels comprising at least one reel from the starting set and at least one replacement reel;
instruct the video terminal machine to execute a second reel spin by modifying the depiction of the modified set of reels on the display screen to portray the reels in the modified set spinning, compute a second stopping position for each of the reels in the modified set, and then instruct the video terminal machine to modify the depiction on the display screen to portray each of the reels in the modified set stopped at its respective second stopping position;
determine a payout based on the second stopping positions of the reels in the modified set; and
instruct the video terminal machine to indicate the payout to the user.
